(19) United States
(12) Patent Application Publication
(10) Pub. No.: US 2016/0310367 A1
(43) Pub. Date: Oct. 27, 2016

(54) Baby bottle

(71) Applicant: Chun-Lu Lin, Taipei (TW)

(72) Inventor: Chun-Lu Lin, Taipei (TW)

(21) Appl. No.: 15/201,506

(22) Filed: Jul. 4, 2016

(51) Int. Cl. A61J 11/02; A61J 11/04; A61J 9/00

(52) U.S. Cl. CPC A61J 11/02; A61J 9/00; A61J 11/04

(57) ABSTRACT

A baby bottle includes a container including an externally threaded top having an opening; a cap including a base, an annular inner wall, a hole member through a bottom of a center of a base, an annular outer wall in close proximity to the opening, an annular flange extending outwardly from a top of the annular outer wall to rest upon the externally threaded top, an annular groove defined between and by the inner wall and the outer wall, and an orifice through a bottom of the groove; a teat including two splay holes, and an anti-vacuum skirt on the flange and being in close proximity to the inner wall; and an internally threaded retainer ring secured to the externally threaded top to fasten the container, the teat, and the cap together.

### BACKGROUND OF THE INVENTION

1. Field of the Invention

The invention relates to baby bottles and more particularly to a baby bottle having improved characteristics.

2. Description of Related Art

A conventional baby bottle is shown in FIGS. 1 to 5B and comprises a container A for storing a quantity of liquid D such as infant formula, juices, or the like, the container A including an externally threaded top A2 having an opening A1; a teat B disposed on the top A2 and including a hole B1 for flowing liquid, and a retainer ring C put on both the base of the teat B and the top A2 and including an opening C1 for allowing a substantial portion of the teat B to pass through, and internal threads C2 to secure to the externally threaded top A2.

However, the conventional baby bottle suffers a number of drawbacks as detailed below.

A repeated upward and downward shake of the baby bottle may spill the liquid D via the hole B1 (see FIGS. 2A and 2B). An infant E may use two arms El to hold the container A and dispose the teat B proximate the mouth to feed itself. However, the liquid D may flow out of the teat B to disperse a substantial portion of the head E2 including the mouth, the nose, and the face due to strong inclined pouring of the liquid D (see FIG. 3). The teat B may disengage from the retainer ring C when the infant E strongly sucks the teat B by using the teeth. As a result, the liquid D spills to the nose and the face (see FIGS. 4A and 4B). Finally, the diameter of the hole B1 may become larger after a long period of time of being sucked by an infant (see FIGS. 5A and 5B). This can adversely change the predetermined flow rate of the liquid D in feeding.

Thus, the need for improvement still exists.

### SUMMARY OF THE INVENTION

It is therefore one object of the invention to provide a baby bottle comprising a container for storing a quantity of liquid and including an externally threaded top having an opening; a cap including a base, an annular inner wall, a hole member through a bottom of a center of a base, an annular outer wall in close proximity to the opening, an annular flange extending outwardly from a top of the annular outer wall to rest upon the externally threaded top, an annular groove defined between and by the inner wall and the outer wall, and an orifice through a bottom of the groove; a teat including two splay holes on a top, and an anti-vacuum skirt disposed on the flange and being in close proximity to the inner wall; and a retainer ring including internal threads secured to the externally threaded top to fasten the container, the teat, and the cap together.

The above and other objects, features and advantages of the invention will become apparent from the following detailed description taken with the accompanying drawings.

### BRIEF DESCRIPTION OF THE DRAWINGS

FIG. 1 is an exploded view of a conventional baby bottle;

FIG. 2A is a longitudinal sectional view of the baby bottle filled with liquid;

FIG. 2B is a view similar to FIG. 2A showing liquid spill by shaking;

FIG. 3 is an environmental view showing an infant being fed by itself by holding the baby bottle;

FIG. 4A schematically shows liquid being fed to the infant by sucking;

FIG. 4B is a view similar to FIG. 4A showing the teat being disengaged from the baby bottle due to a strong sucking of the teat;

FIG. 5A is a longitudinal sectional view of an upper portion of the teat;

FIG. 5B is a view similar to FIG. 5A showing the hole of the teat become larger after a period of time of use;

FIG. 6 is an exploded view of a baby bottle according to the invention;

FIG. 7 is a broken-away perspective view of the teat;

FIG. 8 is a broken-away perspective view of the cap;

FIG. 9 is a longitudinal sectional view of an upper portion of the assembled baby bottle;

FIG. 10A schematically shows the teat partially inserted into the mouth prior to feeding;

FIG. 10B is a view similar to FIG. 10A schematically showing liquid being fed to the infant by sucking;

FIG. 11A is a longitudinal sectional view of an upper portion of the teat filled with liquid; and

FIG. 11B is a view similar to FIG. 11A schematically showing the upper portion of the teat being compressed when feeding.

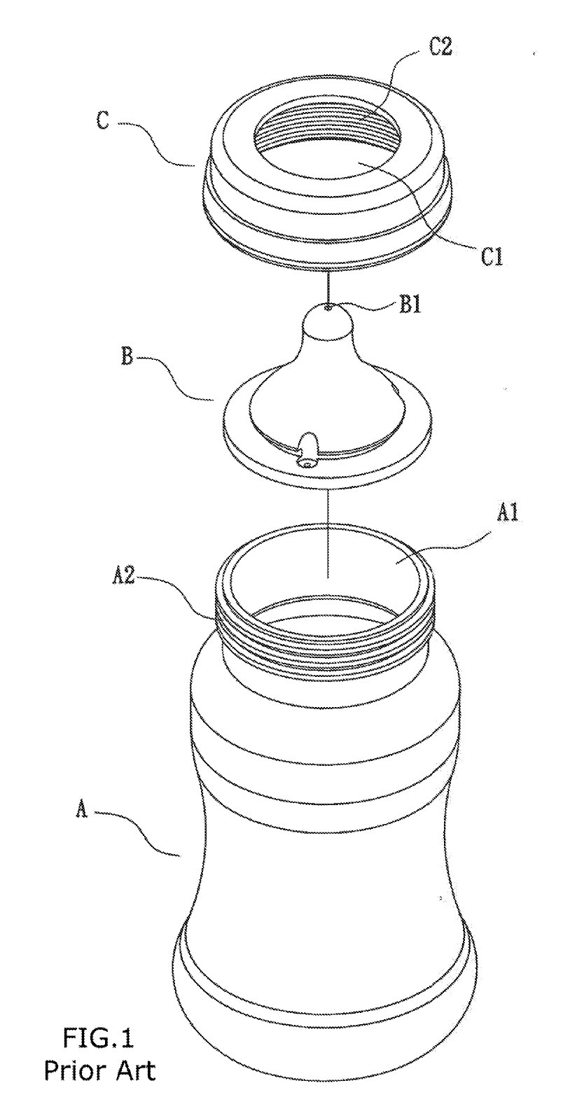

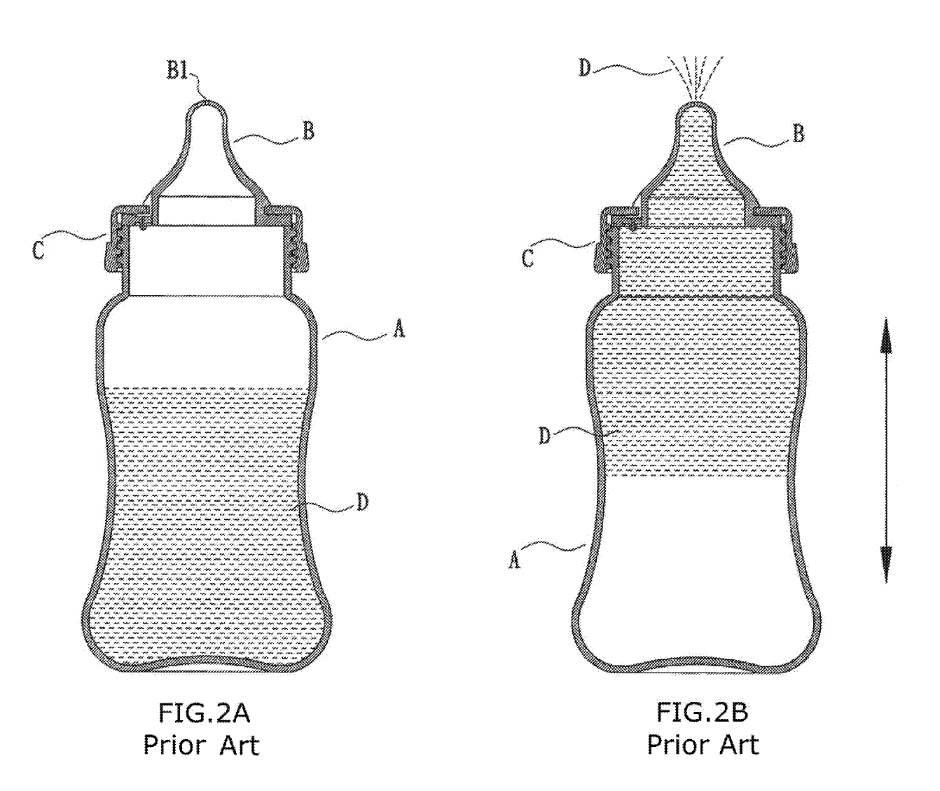

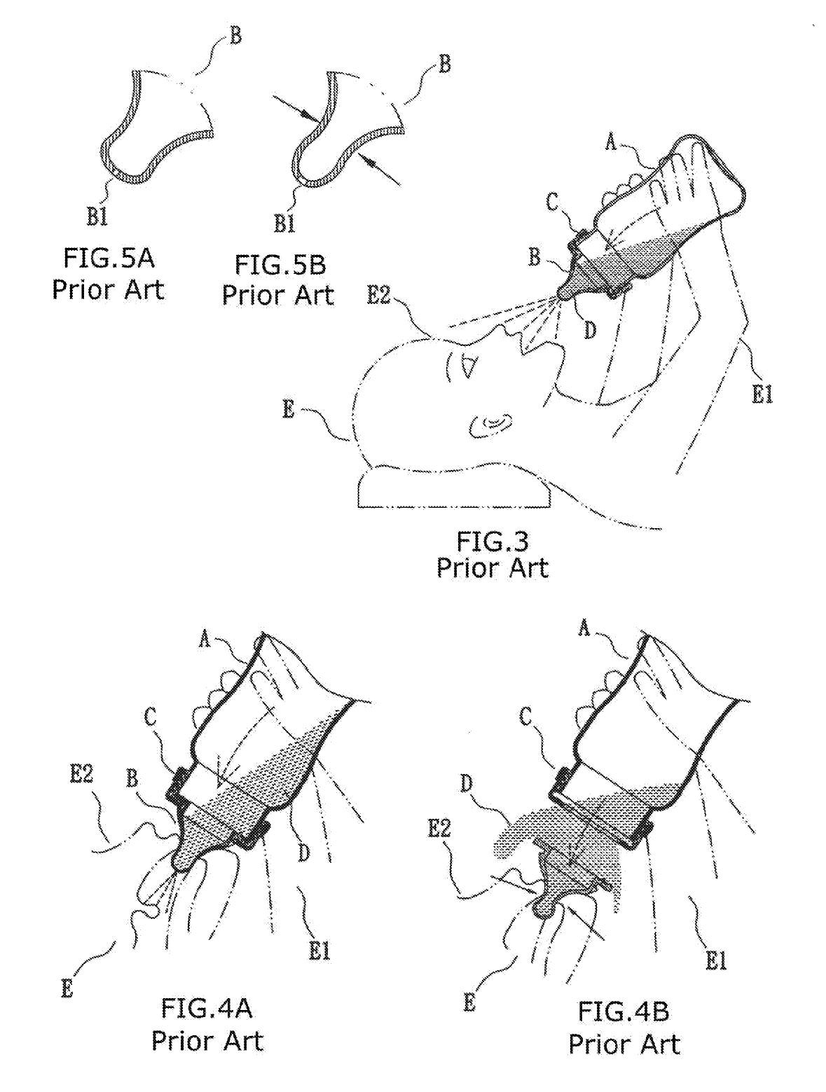

### DETAILED DESCRIPTION OF THE INVENTION

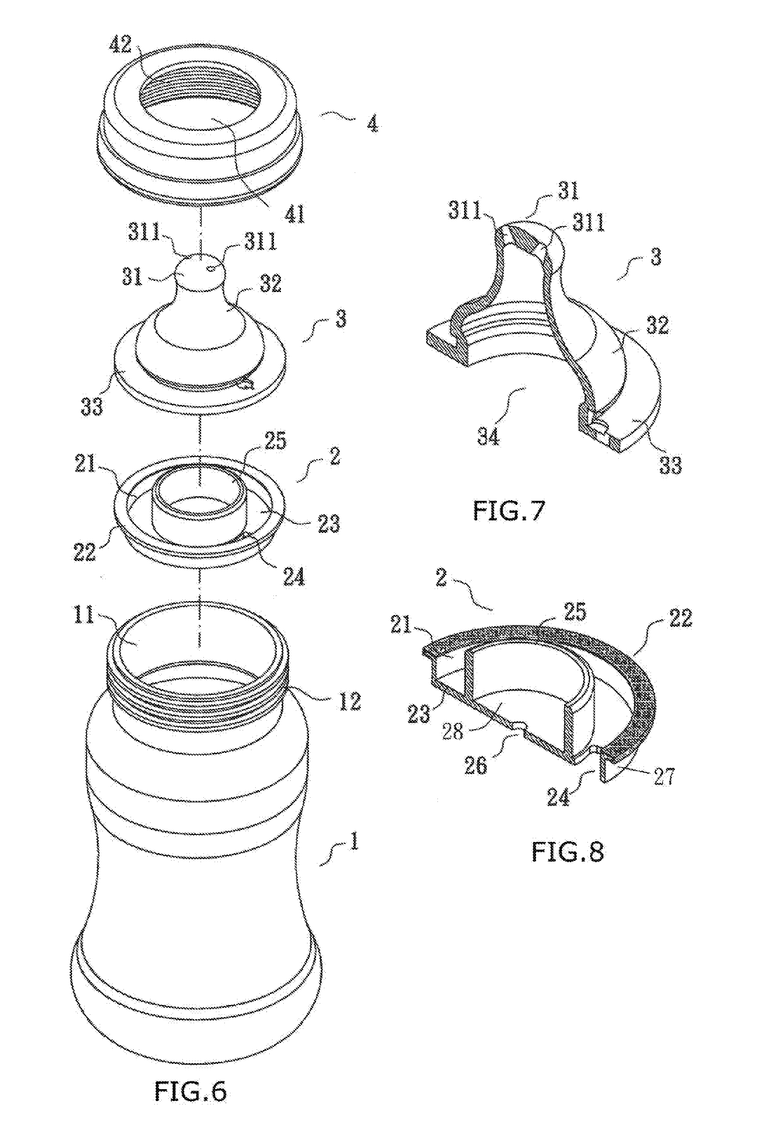

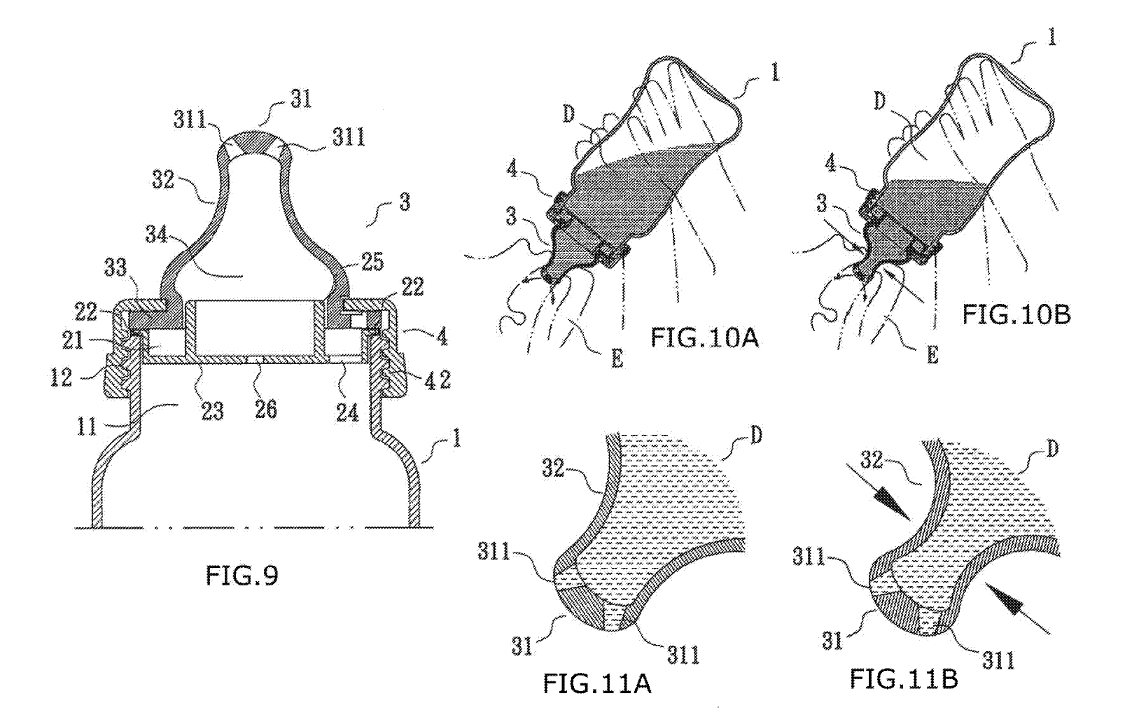

Referring to FIGS. 6 to 11B, a baby bottle in accordance with the invention comprises the following components as discussed in detail below.

A container 1 for storing a quantity of liquid D such as infant formula, juices, or the like is provided. The container 1 includes an externally threaded top 12 having an opening 11. A cap 2 includes an annular inner wall 25, a hole member 26 on a bottom of a center of a base 23, an annular outer wall 27 in close proximity to the opening 11, an annular flange 22 extending outwardly from a top of the annular outer wall 27 to rest upon a top of the externally threaded top 12, an annular groove 23 defined between and by the inner wall 25 and the outer wall 27, and an orifice 24 on a bottom of the groove 23. A teat 3 includes two splay holes 311 on a top 31, an anti-vacuum skirt 33 disposed on a top of the flange 22 and being in close proximity to the inner wall 25, an intermediate portion 32 between the top 31 and the skirt 33, and an internal space 34 communicating with the a space 28 defined by the inner wall 25. A retainer ring 4 includes an axial channel 41 and internal threads 42 secured to the externally threaded top 12 to fasten the container 1, the teat 3, and the cap 2 together. As a result, a leak proof seal of the baby bottle is obtained.

In a feeding operation, an infant E may hold the container 1 in an inclined angle and partially insert the teat 3 into the mouth. The liquid D my flow from the container 1 to the holes 311 via the hole member 26, the space 28, and the space 34. Thereafter, the infant E may bite an upper portion of the teat 3 to suck the liquid D.

The invention has the following advantages: Flow rate of the liquid D is regulated. No spill in feeding. No disengagement of the teat 3 from the retainer ring 4. No enlargement of the holes 311 after a period of time of use.

While the invention has been described in terms of preferred embodiments, those skilled in the art will recognize that the invention can be practiced with modifications within the spirit and scope of the appended claims.

What is claimed is:

1. A baby bottle comprising:
a container for storing a quantity of liquid and including an externally threaded top having an opening;
a cap including a base, an annular inner wall, a hole member through a bottom of a center of a base, an annular outer wall, an annular flange extending outwardly from a top of the annular outer wall to rest upon the externally threaded top, an annular groove defined between and by the inner wall and the outer wall, and an orifice through a bottom of the groove;
a teat including two splay holes on a top, and an anti-vacuum skirt disposed on the flange and being adjacent to the inner wall; and
a retainer ring including internal threads secured to the externally threaded top to fasten the container, the teat, and the cap together.
